(19) United States
(12) Patent Application Publication
(10) Pub. No.: US 2023/0325713 A1
(43) Pub. Date: Oct. 12, 2023

(54) MANAGING MACHINE LEARNING TRAINING AND MACHINE LEARNING MODEL TRAINING CONTROL

(71) Applicant: NOKIA TECHNOLOGIES OY, Espoo (FI)

(72) Inventors: Stephen MWANJE, Dorfen (DE); Abdelrahman ABDELKADER, Munich (DE)

(21) Appl. No.: 18/122,909

(22) Filed: Mar. 17, 2023

Related U.S. Application Data
(60) Provisional application No. 63/323,713, filed on Mar. 25, 2022.

(51) Int. Cl. G06N 20/00

(52) U.S. Cl. CPC G06N 20/00

(57) ABSTRACT

Systems, methods, apparatuses, and computer program products for managing machine learning training. One method may include a machine learning training function receiving a request to instantiate a machine learning training job from a consumer, and instantiating the requested machine learning training job. The machine learning training function may transmit a notification to the consumer indicating that the machine learning training job has been instantiated.

### CROSS REFERENCE TO RELATED APPLICATION

This application claims the benefit of U.S. Provisional Pat. Application No. 63/323,713, filed Mar. 25, 2022. The entire content of the above-referenced application is hereby incorporated by reference.

### TECHNICAL FIELD

Some example embodiments may generally relate to mobile or wireless telecommunication systems, such as Long Term Evolution (LTE), fifth generation (5G) radio access technology (RAT), new radio (NR) access technology, and/or other communications systems. For example, certain example embodiments may relate to systems and/or methods for managing machine learning training, for example, in cognitive autonomous networks (CANs).

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include receiving, by a machine learning training function, a request to instantiate a machine learning training job from a consumer. The method may further include instantiating, by the machine learning training function, the requested machine learning training job. The method may further include transmitting, by the machine learning training function, a notification to the consumer indicating that the machine learning training job has been instantiated.

In accordance with certain example embodiments, an apparatus may include means for receiving a request to instantiate a machine learning training job from a consumer. The apparatus may further include means for instantiating the requested machine learning training job. The apparatus may further include means for transmitting a notification to the consumer indicating that the machine learning training job has been instantiated.

In accordance with various example embodiments, a non-transitory computer readable medium may be encoded with instructions that may, when executed in hardware, perform a method. The method may include receiving a request to instantiate a machine learning training job from a consumer. The method may further include instantiating the requested machine learning training job. The method may further include transmitting a notification to the consumer indicating that the machine learning training job has been instantiated.

In accordance with some example embodiments, a computer program product may perform a method. The method may include receiving a request to instantiate a machine learning training job from a consumer. The method may further include instantiating the requested machine learning training job. The method may further include transmitting a notification to the consumer indicating that the machine learning training job has been instantiated.

In accordance with certain example embodiments, an apparatus may include at least one processor and at least one memory including computer program code. The at least one memory and the computer program code may be configured to, with the at least one processor, cause the apparatus to at least receive a request to instantiate a machine learning training job from a consumer. The at least one memory and the computer program code may be further configured to, with the at least one processor, cause the apparatus to at least instantiate the requested machine learning training job. The at least one memory and the computer program code may be further configured to, with the at least one processor, cause the apparatus to at least transmit a notification to the consumer indicating that the machine learning training job has been instantiated.

In accordance with various example embodiments, an apparatus may include circuitry configured to receive a request to instantiate a machine learning training job from a consumer. The circuitry may further be configured to instantiate the requested machine learning training job. The circuitry may further be configured to transmit a notification to the consumer indicating that the machine learning training job has been instantiated.

In accordance with some example embodiments, a method may include transmitting, by a consumer, a request to instantiate a machine learning training job to a machine learning training function. The method may further include receiving, by the consumer, a notification from the machine learning training function indicating that the machine learning training job has been instantiated.

In accordance with certain example embodiments, an apparatus may include means for transmitting a request to instantiate a machine learning training job to a machine learning training function. The apparatus may further include means for receiving a notification from the machine learning training function indicating that the machine learning training job has been instantiated.

In accordance with various example embodiments, a non-transitory computer readable medium may be encoded with instructions that may, when executed in hardware, perform a method. The method may include transmitting a request to instantiate a machine learning training job to a machine learning training function. The method may further include receiving a notification from the machine learning training function indicating that the machine learning training job has been instantiated.

In accordance with some example embodiments, a computer program product may perform a method. The method may include transmitting a request to instantiate a machine learning training job to a machine learning training function. The method may further include receiving a notification from the machine learning training function indicating that the machine learning training job has been instantiated.

In accordance with certain example embodiments, an apparatus may include at least one processor and at least one memory including computer program code. The at least one memory and the computer program code may be configured to, with the at least one processor, cause the apparatus to at least transmit a request to instantiate a machine learning training job to a machine learning training function. The at least one memory and the computer program code may be further configured to, with the at least one processor, cause the apparatus to at least receive a notification from the machine learning training function indicating that the machine learning training job has been instantiated.

In accordance with various example embodiments, an apparatus may include circuitry configured to transmit a request to instantiate a machine learning training job to a machine learning training function. The circuitry may further be configured to receive a notification from the machine learning training function indicating that the machine learning training job has been instantiated.

### BRIEF DESCRIPTION OF THE DRAWINGS

For a proper understanding of example embodiments, reference should be made to the accompanying drawings, wherein:

FIG. 1 illustrates an example of a management and control of the MLModel training process according to certain example embodiments.

FIG. 2 illustrates an example of an information model for MLModel training control according to some example embodiments.

FIG. 3 illustrates an example of ML training inheritance relations according to various example embodiments.

FIG. 4 illustrates an example of instantiating an MLTrainingJob based on an operator’s request according to certain example embodiments.

FIG. 5 illustrates an example of modifying the characteristics of one or more ongoing or completed MLTrainingJobs according to some example embodiments.

FIG. 6 illustrates an example of reading the characteristics of one or more ongoing or completed MLTrainingJobs according to various example embodiments.

FIG. 7 illustrates an example of deleting one or more ongoing or completed MLTrainingJobs according to certain example embodiments.

FIG. 8 illustrates an example of reading characteristics of one or more MLTrainingRequests according to some example embodiments.

FIG. 9 illustrates an example of modifying characteristics of one or more MLTrainingRequests according to various example embodiments.

FIG. 10 illustrates an example of deleting one or more MLTrainingRequests according to certain example embodiments.

FIG. 11 illustrates an example of requesting and reporting on MLModel training according to some example embodiments.

FIG. 12 illustrates an example of a ML training information model according to various example embodiments.

FIG. 13 illustrates an example of instantiating an MLTrainingJob based on multiple requests from consumer functions according to certain example embodiments.

FIG. 14 illustrates an example of reading the characteristics of one or more ongoing or completed MLTrainingJobs according to some example embodiments.

FIG. 15 illustrates an example of reading the characteristics of one or more ongoing or completed MLTrainingJobs according to various example embodiments.

FIG. 16 illustrates an example of deleting one or more ongoing or completed MLTrainingJobs according to certain example embodiments.

FIG. 17 illustrates an example of reading the characteristics of one or more ongoing or completed MLTrainingJobs according to some example embodiments.

FIG. 18 illustrates an example of modifying the characteristics of one or more ongoing or completed MLTrainingJobs according to various example embodiments.

FIG. 19 illustrates an example of deleting one or more ongoing or completed MLTrainingJobs according to some example embodiments.

FIG. 20 illustrates an example of a flow diagram of a method according to various example embodiments.

FIG. 21 illustrates an example of a flow diagram of a method according to some example embodiments.

FIG. 22 illustrates an example of a flow diagram of a method according to certain example embodiments.

FIG. 23 illustrates an example of a flow diagram of a method according to various example embodiments.

FIG. 24 illustrates an example of various network devices according to some example embodiments.

FIG. 25 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for managing machine learning training is not intended to limit the scope of certain example embodiments, but is instead representative of selected example embodiments.

CANs may provide intelligence and autonomy to network operations, administration and management (OAM) functions, as well as support the increased flexibility and complexity of the radio network. By using machine learning (ML) and artificial intelligence (AI) in the cognitive functions, CANs may take higher level goals and derive the appropriate performance targets, learn from their environment and their individual or shared experiences therein, learn to contextualize their operating conditions, and learn their optimal behavior fitting to the specific environment and contexts. As an example, cognitive automation may be used for handover optimization.

In order to realize these advantages, ML models (MLModel) may be trained with appropriate network data, including within the network where the MLModel is expected to be deployed. As a result, the network may not only need to possess the required training capabilities, but also the means to manage the training of the MLModels.

As an example, MLModels may be an independently-managed entity in which training is done by adjusting the model; alternatively, the MLModel may be an entity within a managed ML-based function or application (i.e., MLApp), wherein case training may imply implementing the necessary means to enable the MLApp to train the model inside it.

As used within this disclosure, “MLModel Training” may refer to capabilities that directly adjust parameterization of an ML Model based on experience from data. Similarly, “ML Training” may refer to capabilities that may enable a ML-based function or application (i.e., MLApp) that adjust the parameterization of its constituent ML Model based on experience from data. Consequently, MLModel Training may be a subset of ML Training since the MLApp for which ML Training is enabled may undertake MLModel Training as an internal activity.

One of the challenges with existing MLModels is their need to be trained with specific inputs and training features that apply to the use case and applied ML algorithms. For example, required training may need to be performed by functions different from those use-trained models for inferences. As a result, the network system may need to support means through which the inference functions can request the training functions to train any specific model, as well as training functions that may report on the trained models or its training process. For example, information elements may need to be defined to support the request of training for a specified model with specific conditions under which the model shall be deployed. Furthermore, training functions may need general capabilities for managing the ML-Model training functions, and the related ML-Model training processes. For example, the ML-Model training functions and processes may need to be modelled as managed functions while information elements need to be defined to support the triggering of the training process. As such, OAM systems may need to be extended with the ML-Model training management capabilities; for example, a solution may be required to provide means for managing training including triggering training and controlling the training process or job.

As will be discussed in further detail below, various example embodiments may relate to standards-based means for requesting and reporting ML training that addresses both the scenarios where the ML model is either a managed object or an attribute of a managed function. Furthermore, some example embodiments standards-based means for managing ML-Model training functions and the related ML-Model training processes.

Certain example embodiments described herein may have various benefits and/or advantages to overcome the disadvantages described above. For example, certain example embodiments may enable an operator to control and manage ML training processes, and/or allow management functions to interact with ML training functions to control the ML training processes. Furthermore, various example embodiments may enable an authorized consumer, network managed function, or management function to request the training of a ML model with specific characteristics related to operation and termination conditions. Some example embodiments may also define the reporting mechanism used to inform the consumer about the ML model training including the report request and report itself, as well as specify the end-to-end flow of operations (i.e., requests/responses/reports) related to training a ML model. Thus, certain example embodiments discussed below are directed to improvements in computer-related technology.

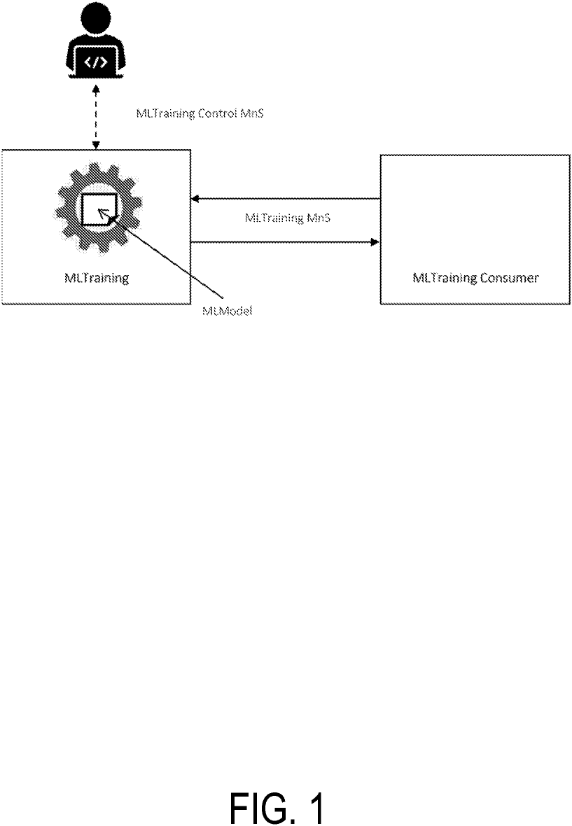

In various example embodiments, a ML-Model training function (i.e., MLTraining) and the related services may support management and control of the training process and the related requests associated with a specific ML Model (i.e., MLModel). As illustrated in FIG. 1, and discussed in more detail below, an authorized consumer may create an MLModel training instance (i.e., MLTrainingJob). MLTraining may receive one or more requests to train an MLModel, and may subsequently instantiate an MLTrainingJob associated with the received requests and the specified MLModel. FIG. 1 also depicts an authorized consumer configured to manage one or more requests for training MLModels (i.e., MLTrainingRequests). The MLModel training process may also include an authorized consumer (e.g. an operator) configured to control a specific MLTrainingJob (e.g., to start, suspend, or restart the training; or to adjust the training conditions or characteristics). In general, the MLTraining may be modelled as a managed function that is contained in either any network-related ManagedFunction, ManagementFunction or subnetwork. The MLTraining may contain or be associated with critical subfunctions and modules needed to accomplish MLTraining, including a list of MLTraining requests, a list of MLModels either under training or to be considered for training, and a list of MLTrainingJobs. The MLTraining may have the capability and interfaces to instantiate an MLTrainingJob based on instructions from management functions or human operators. The MLTraining may also have the capability, such as via a control interface, to enable an operator or a management function to configure and manage one or more MLTrainingJobs.

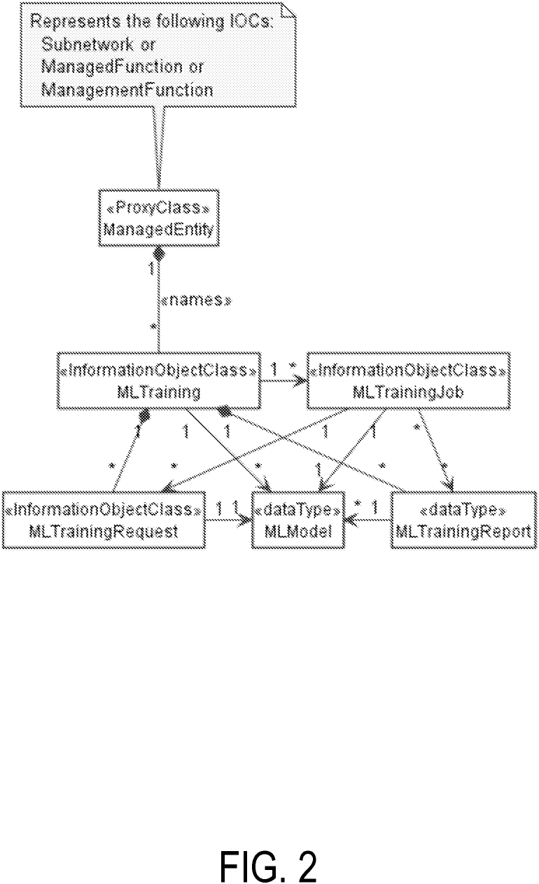

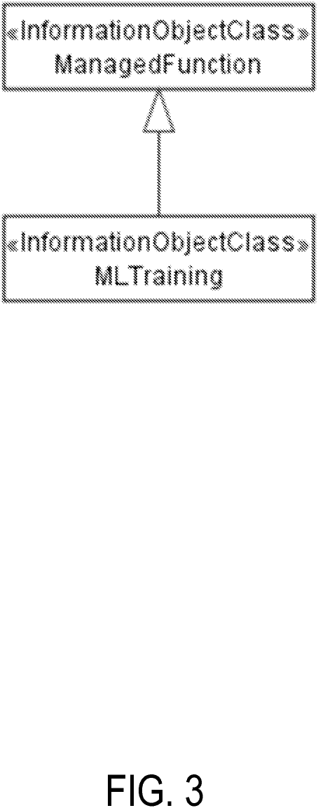

As summarized above, an MLTraining information model may include information object classes (IOCs) and dataTypes needed to realize MLTraining, as well as the relationships among these IOCs and dataTypes. FIGS. 2 and 3 model the MLTraining in more detail. The IOC of the MLTraining represents the properties of MLTraining. MLTraining may be a managed object instantiable from the MLTraining IOC, and name-contained in either a subnetwork, a ManagedFunction, or a ManagementFunction. The MLTraining may be a type of managedFunction (i.e., the MLTraining is a subclass of and inherits the capabilities of a managedFunction).

In various example embodiments, the MLTraining may be associated with one or more MLModels. The MLModels may also be part of the MLTraining, or may be independent of the MLTraining. The MLModels associated with MLTraining may be name contained within the MLTraining, or may be only associated via a list of MLModelIdentifers. Correspondingly, both the MLModelsList and the MLModels may be conditionally mandatory in that at least one of them must be provided. The MLTraining may contain one or more MLTrainingRequests. The MLTraining IOC may include attributes inherited from TOP IOC (similar to those defined in 3GPP TS 28.622) and/or the following attributes:

| | | | | | |
|---|---|---|---|---|---|
| Attribute name | Support Qualifier | isReadable | isWritable | isInvariant | isNotifyable |
| mlModelsList | CM | T | F | F | F |
| mlModels | CM | T | F | F | F |
| MLTrainingJobs | M | T | F | F | F |
| MLTrainingRequests | M | T | T | F | T |

In various example embodiments, the IOC of the MLTrainingJob may represent the properties of MLTrainingJob. For each MLModel under training, a MLTrainingJob may be instantiated (i.e., the MLTrainingJob associated with exactly one MLModel). The MLTrainingJob may be associated with one or more MLTrainingRequests. The MLTrainingJob may need to be managed separately from the MLTrainingRequests (e.g., the MLTrainingRequests may come from consumers which are network functions, while the operator may wish to manage the MLTrainingJob that is instantiated following the requests). As an example, the MLTrainingJob may not correspond to a specific MLTrainingRequest (i.e., a MLTrainingRequest does not have to be associated to a specific MLTrainingJob). Instead, the MLTrainingJob may be associated to either one or more MLTrainingRequests.

In some example embodiments, each MLTrainingJob may be managed differently from the related MLModel, although the MLTrainingJob may be associated to only one MLModel. For example, the MLTrainingJob may be triggered to start with a specific version of the MLModel, and multiple MLTrainingJobs may be triggered for different versions of the MLModels. In either case, the MLTrainingJobs may be associated with the same MLModel, but managed separately from the MLModel. Furthermore, each MLTrainingJob may be a priority that may be used to prioritize the execution of different MLTrainingJobs. By default, the priority of the MLTrainingJob may be related in a 1:1 manner with the priority of the MLTrainingRequests for which the MLTrainingJob is instantiated. Additionally or alternatively, each MLTrainingJob may have an attribute for one or more termination conditions used to define the points at which the MLTrainingJob may terminate. Each MLTrainingJob may also have a status attribute used to indicate the level of success of the MLTrainingJob.

In certain example embodiments, the MLTrainingJob IOC may include attributes inherited from TOP IOC (such as those defined in 3GPP TS 28.622), and/or the following attributes:

| | | | | | |
|---|---|---|---|---|---|
| Attribute name | Support Qualifier | isReadable | isWritable | isInvariant | isNotifyable |
| MLTrainingJobID | M | T | F | F | F |
| mlModel | M | T | F | F | F |
| MLTrainingRequests | M | T | T | F | T |
| priority | M | T | T | F | T |
| Termination conditions | M | T | T | F | T |
| ProgressStatus | M | T | T | F | T |

In various example embodiments, the IOC may represent the properties of MLTrainingRequest. For example, for each request to undertake training, a consumer may create a new MLTrainingRequest on the MLTraining (i.e., MLTrainingRequest may be an IOC that is instantiated for each request for training). For example, each MLTrainingRequest may be associated with exactly one MLModel associated to the MLTraining to which the MLTrainingRequest is sent. Furthermore, each MLTrainingRequest may contain specific reporting requirements that define how the MLTraining may report about the MLTrainingRequest. The MLTrainingRequest may be associated with an MLTrainingJob, if such MLTrainingJob has been instantiated and is related to that MLTrainingRequest. For example, if the MLTraining requires that an MLTrainingJob is instantiated only after a number n of MLTrainingRequests, each MLTrainingRequest may be associated with the MLTraining whenever such a MLTrainingJob is instantiated. In various example embodiments, the MLTrainingRequest may have a source to identify where it originates, and which may be used to prioritize among different resources from different sources. As an example, the sources may be an enumeration defined for network functions, operator roles, or other functional differentiations. Each MLTrainingRequest may also indicate one or more termination conditions that define, for the MLTraining, the conditions to be used to terminate the training.

In some example embodiments, each MLTrainingRequest may have a RequestStatus field used to track the status of the specific MLTrainingRequest. The RequestStatus may be written to by the MLTraining when there is a change in status as the training progresses. The RequestStatus may be an enumeration with the following values:

“Pending”: may indicate that the MLTrainingRequest has been received, but no action has been taken in response. When other actions are taken regarding the MLTrainingRequest, the RequestStatus may change to another value.

“Triggered”: when a corresponding MLTrainingJob has been initiated and is running.

“Suspended”: the status when the MLTrainingRequest has been suspended by the MLTraining or another authorized consumer, e.g., the operator.

“Served”: the status when an MLTrainingJob related to the specific MLTrainingRequest has run to completion.

In some example embodiments, the MLTrainingRequest IOC may include attributes inherited from TOP IOC (such as those defined in 3GPP TS 28.622) and the following attributes:

| | | | | | |
|---|---|---|---|---|---|
| Attribute name | Support Qualifier | isReadable | isWritable | isInvariant | isNotifyable |
| MLTrainingRequestID | M | T | F | F | F |
| mlModel | M | T | F | F | F |
| MLTrainingJob | M | T | F | F | F |
| Source | M | T | T | F | T |
| RequestStatus | M | T | T | F | T |
| expectedRuntimeContext | | | | | |

In various example embodiments, the MLModel may include dataType representing the properties of an MLModel. For each MLModel under training, an MLTrainingJob may be instantiated. The MLTraining may instantiate an MLTrainingJob for each MLTrainingRequest, and/or may instantiate an MLTrainingJob for a set of MLTrainingRequests As an example, the training function may require that an MLTrainingJob may be instantiated following multiple MLTrainingRequests from different consumers. The MLModel may include the attributes inherited from TOP IOC (such as defined in 3GPP TS 28.622).

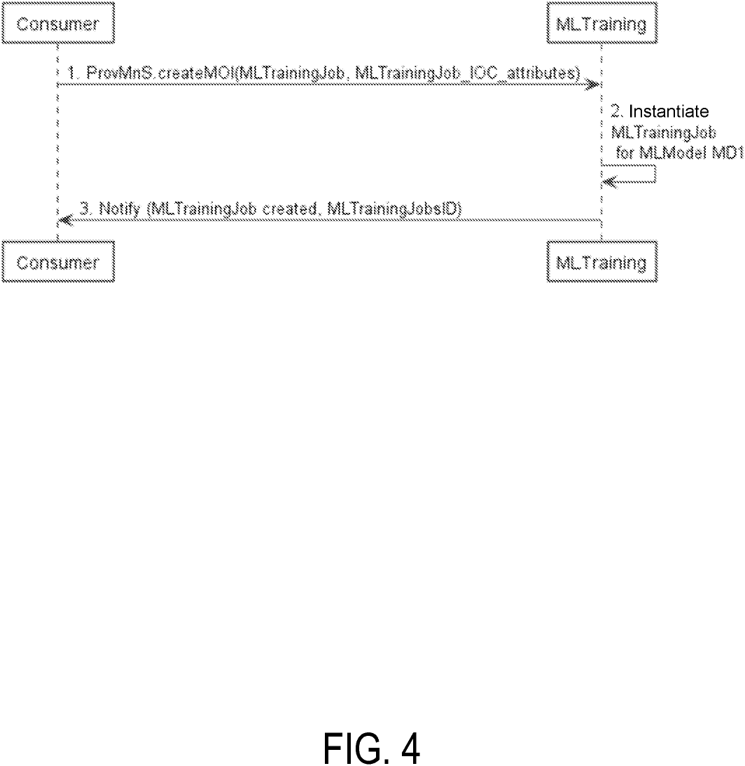

In certain example embodiments, the MLTraining may instantiate an MLTrainingJob based on at least one MLTrainingRequest from consumers who may be management functions or human operators. For example, the MLTraining may instantiate an ML MLTrainingJob for each received instruction, as illustrated in FIG. 4. For example, requests for training may be received via MLTraining Provisioning Management service implemented via CRUD (Create, Read, Update, Delete) operations on the MLTrainingJob or the MLTrainingRequest objects.

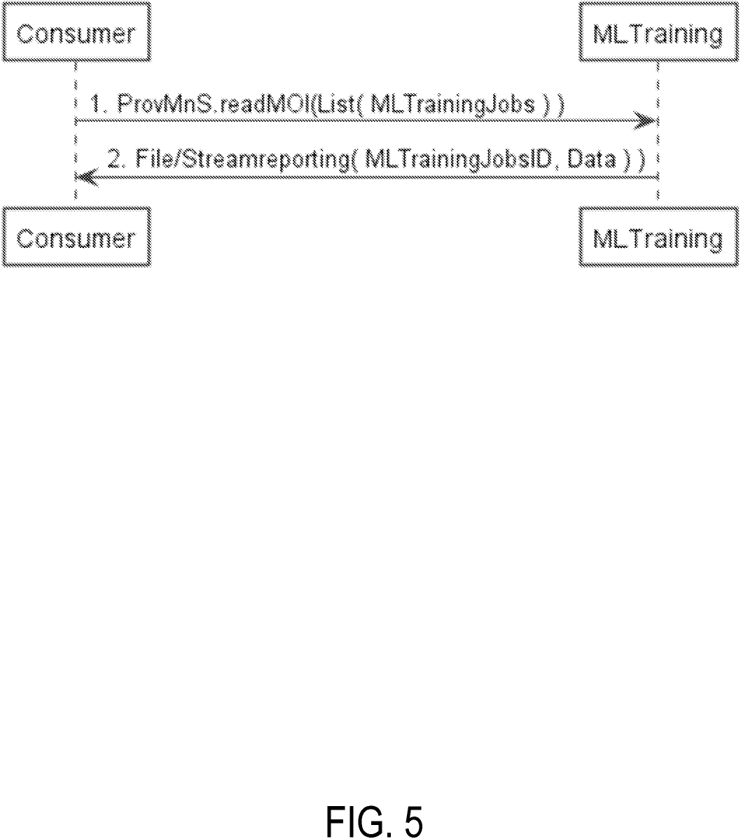

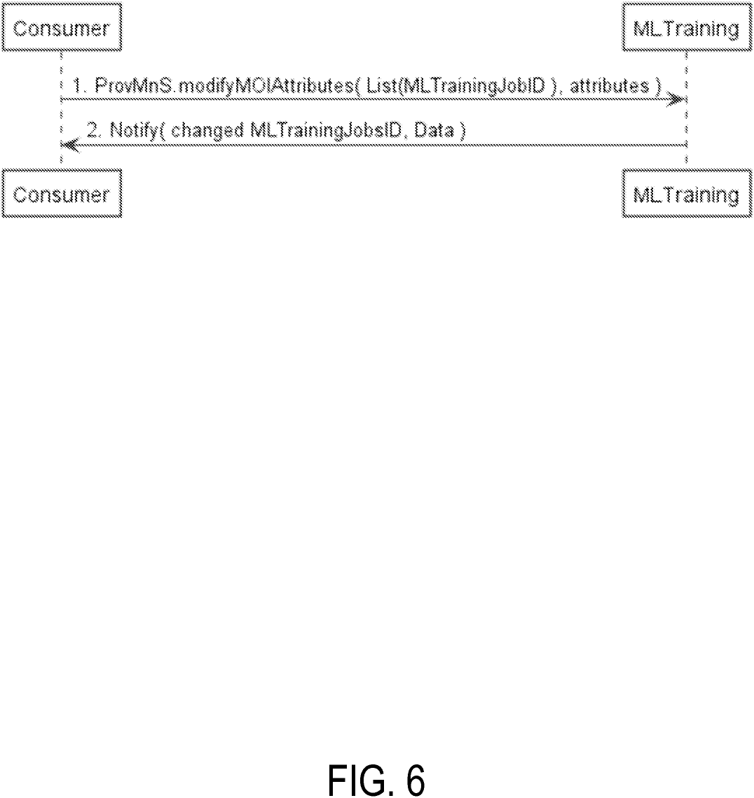

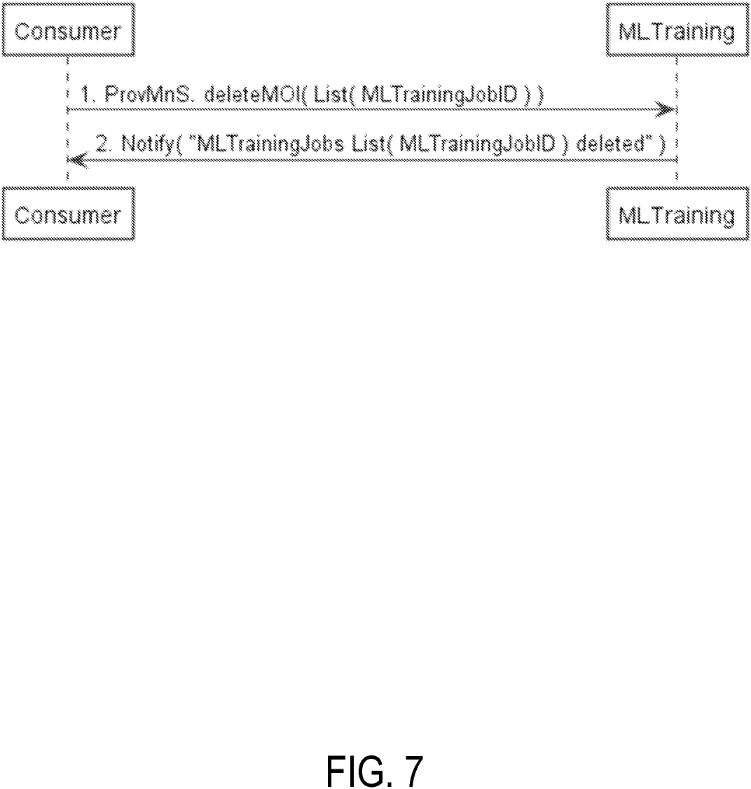

In some example embodiments, the MLTraining may have the capability and a control interface to allow a consumer (e.g., the operator) to configure and manage one or more MLTrainingJobs. As an example, the control interface may enable the consumer to read the characteristics of ongoing or completed MLTrainingJobs. Specifically, the control interface may enable the consumer to read the status or maturity levels of the different MLTrainingJobs; this may be achieved using the readMOI procedure of the 3GPP provisioning management service, as illustrated in FIG. 5. Additionally or alternatively, the control interface may enable the consumer to configure new and ongoing MLTrainingJobs. For example, the operator may assign priorities to one or more MLTrainingJobs to indicate that, in case of resource constraints, some particular MLTrainingJobs with higher priority should be executed first. The configuration may be achieved using the updateMOIAttributes procedure of a provisioning management service, such as depicted in FIG. 6. Following an update request, the MLTraining may notify the consumer about the success of the executed update on the MLTrainingJob(s). Furthermore, the control interface may enable the consumer to delete unwanted MLTrainingJobs, including ongoing and completed MLTrainingJobs. This may be achieved using the deleteMOI procedure of a provisioning management service, such as illustrated in FIG. 7. Following a delete request, the MLTraining may notify the consumer about the success of the executed deletion of MLTrainingJobs.

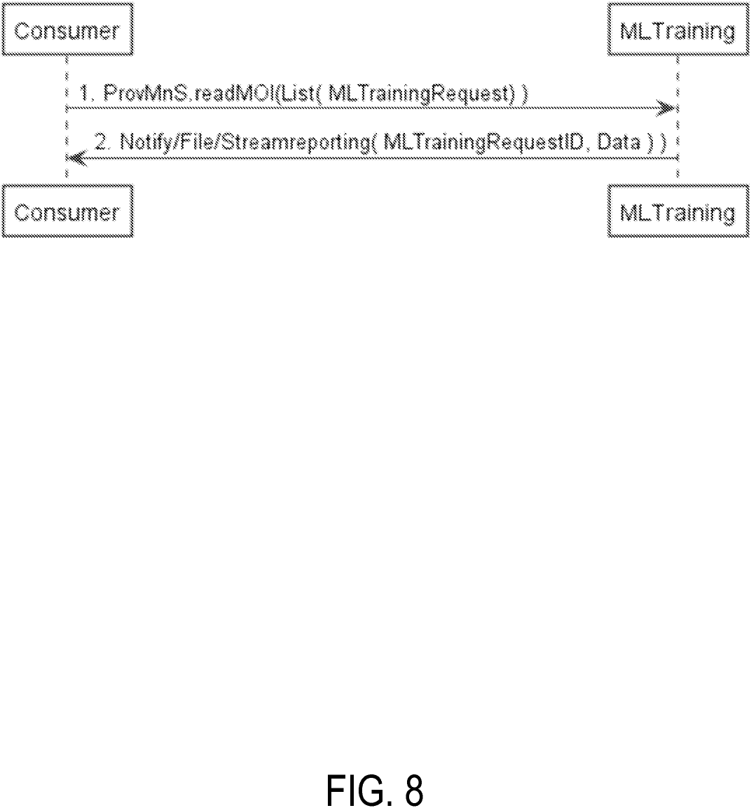

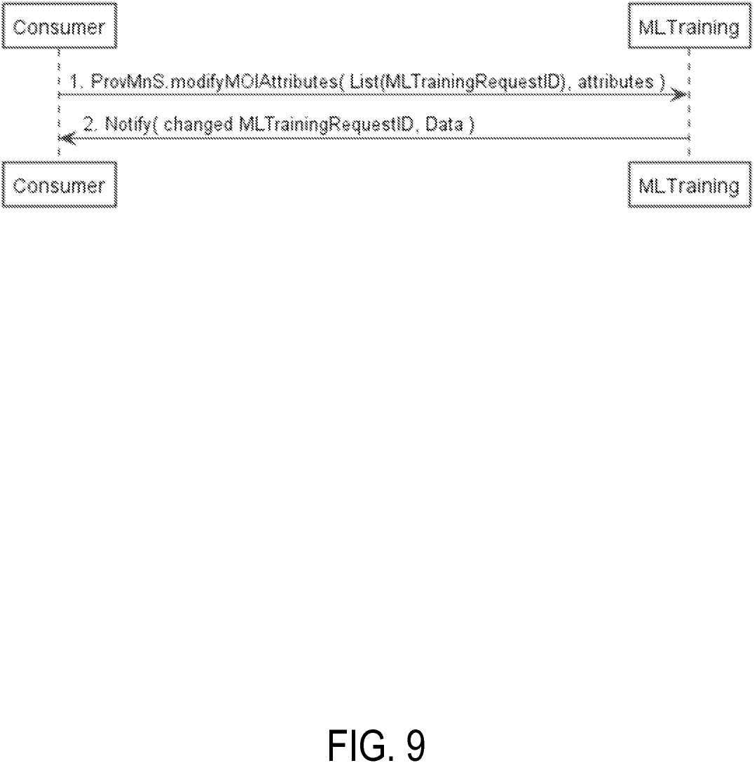

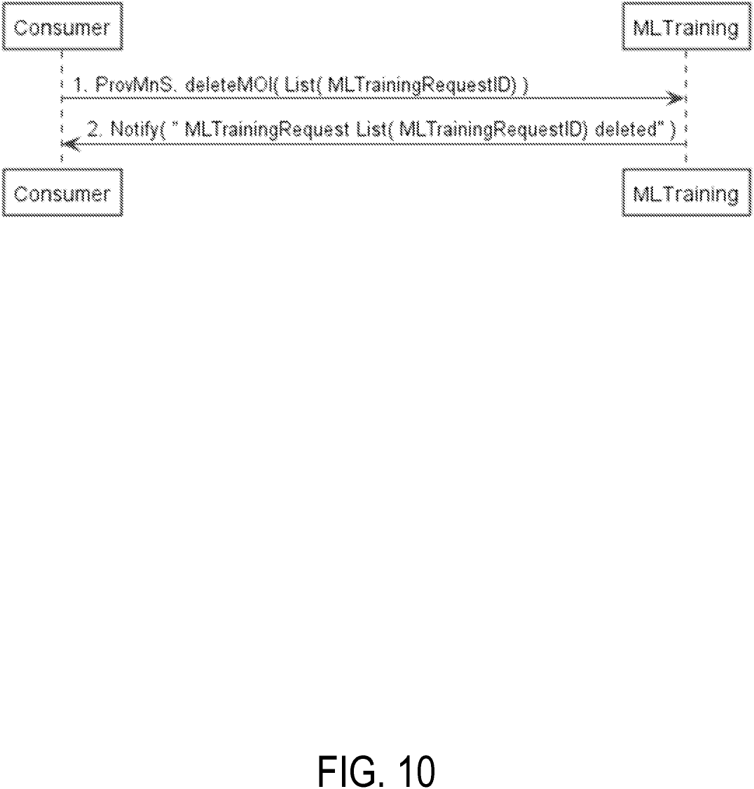

In various example embodiments, the MLTraining may have the capability, via a control interface, to allow a consumer (e.g., the operator) to configure and manage one or more MLTrainingRequests. For example, the control interface may enable the consumer to read the characteristics of submitted MLTrainingRequests. This may be achieved using the readMOI procedure of a provisioning management service, such as shown in FIG. 8. For example, the consumer may read the number of submitted, ongoing or completed MLTrainingRequests; the features (e.g., priorities, expectedRuntimeContext, etc.) of the different submitted or ongoing MLTrainingRequests; and the status or maturity levels of the different MLTrainingRequests. Additionally or alternatively, the control interface may enable the consumer to configure the submitted MLTrainingRequests (e.g., the operator may change the priorities of one or more MLTrainingRequests to indicate those that need to be prioritized regarding the instantiation of the related MLTrainingJobs). Similarly, it may enable a consumer to update the priority of the MLTrainingRequest sent by that consumer (e.g., a priori). As shown in FIG. 9, the configuration may be achieved using the updateMOI procedure of a provisioning management service. Following an update request, the MLTraining may notify the consumer about the success of the executed updates on the MLTrainingRequests. The control interface may, as shown in FIG. 10, enable the consumer to delete unwanted MLTrainingRequests; this may be achieved using the deleteMOI procedure of a provisioning management service. Following a delete request, the MLTraining may notify the consumer about the success of the executed deletion of MLTrainingRequests.

Some various example embodiments may relate to interfaces and capabilities for training ML-Models and MLApps and reporting on the training. This may assume the existence of an ML Training Function (MLTraining) capable of training a specific ML model (MLModel), where the MLModel can be a standalone managed object or an attribute within a MLApp. The functionality within the MLTraining and related services may support requesting and reporting on the MLTraining. For example, an authorized consumer may request the training of a specific MLModel. Accordingly, the MLTraining may receive one or more requests to train an MLModel (MLTrainingRequest), and subsequently instantiate a training process (MLTrainingJob) associated with the received MLTrainingRequest and the specified MLModel. An authorized consumer (e.g., the function/entity that generated a request) may manage the request (e.g., to suspend, re-activate or cancel the training request; or to adjust the desired characteristics of the desired training). In addition, an authorized consumer (e.g., the function/entity that generated a request) may also define the reporting characteristics related to a specific training request or training instance. Furthermore, the MLTraining may report to any authorized consumer about specific MLTrainingJobs and/or report about the outcomes of any such MLTrainingJobs.

It may be assumed that MLTraining is a managed function containing or associated with the list of MLTrainingRequests, with the list of MLModels either under training or to be considered for training as well as MLTrainingJobs associated with these MLModels. The MLTraining may be modelled to contain or be associated with a list of MLTrainingRequests, a list of MLTrainingReports, and/or a list of requests for reporting (MLTrainingReportingRequests). As an example, the MLTraining may implement an MLTraining Management Service (MLTraining MnS) that provides capabilities for requesting training and for reporting on the training. The consumers for such a service may be any managed function or management function that can have a specific model trained, get information about MLTrainingRequests, the untrained MLModels, trained MLModels or the MLTrainingJobs, and/or modify its request for training or modify the reporting about any such training. The interface/management service may also allow the consumer to define the characteristics of the reporting via the training request and/or a specific request for reporting.

Furthermore, training may be requested from the MLTraining by creating an instance of MLTrainingRequest on the MLTraining. The instance may define the MLModel for which training is needed and the characteristics desired for the MLModel. The instance may also define the characteristics of the reporting to be delivered regarding the training request or its subsequent job. Reporting to be delivered by the MLTraining may be defined by providing the appropriate characteristics in the training request or by creating an instance of MLTrainingReportingRequest on the MLTraining. The MLTrainingReports may be compiled in response to specific MLTrainingRequests, on specific MLTrainingJobs, or on specific MLModels. MLTrainingReports may also be compiled on one or more MLModels, on one or more MLTrainingRequests, or on one or more MLTrainingJobs. Similarly, the MLTrainingReportingRequest instance may state the respective MLModels, MLTrainingRequests or MLTrainingJobs for which reporting is needed and the characteristics of the respective reporting.

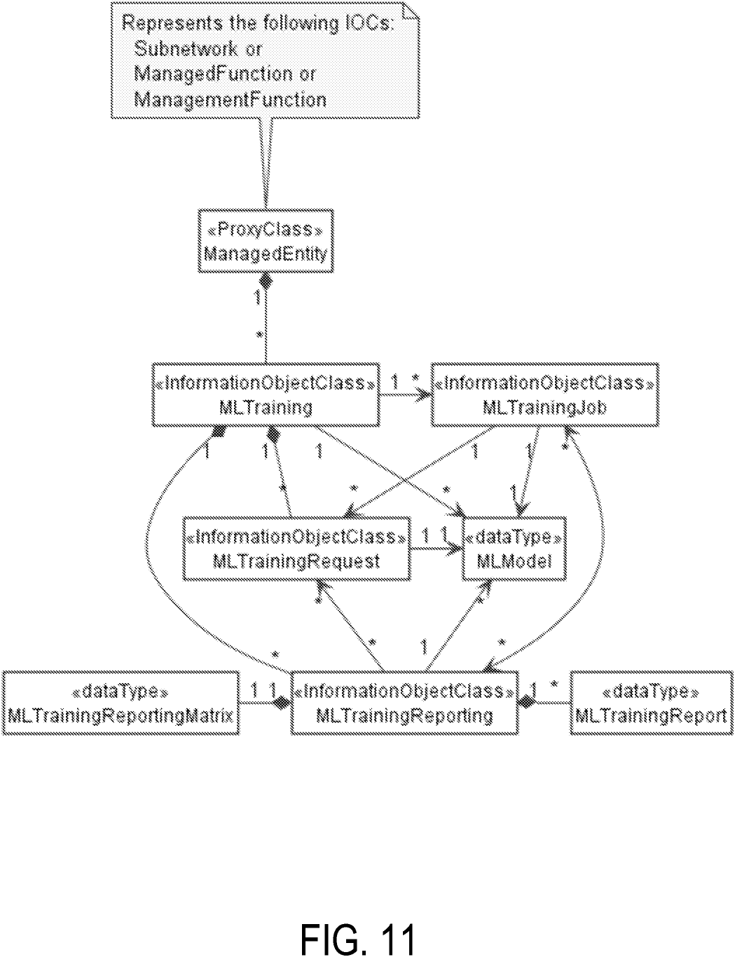

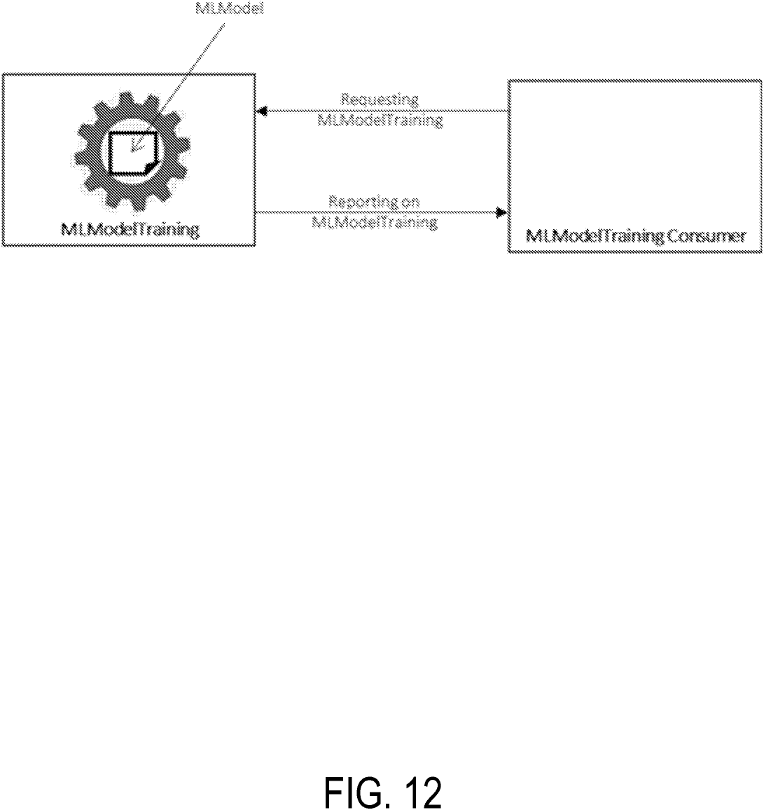

In some example embodiments, the MLTraining information model, such as that illustrated in FIG. 11, may include MLTraining information models that define the IOCs and dataTypes needed to realize requests and reporting for training MLModels, as well as the relationships among these IOCs and dataTypes. As illustrated in FIG. 12, the information model for MLTraining may be extended and modelled to support training requests and the related reporting.

In some example embodiments, this IOC may represent the properties of MLTraining. In addition to the MLTrainingRequests, MLModels and MLTrainingJobs, the MLTraining may be associated with MLTrainingReporting. In addition, MLTrainingReporting may be name-contained within MLTraining since MLTraining may send the reports related to the training. The MLModels may be specified using their respective MLModelIdentifiers. As an example, the MLTraining IOC may include the following attributes:

| | | | | | |
|---|---|---|---|---|---|
| Attribute name | Support Qualifier | isReadable | isWritable | isInvariant | isNotifyable |
| mlModelsList | CM | T | F | F | F |
| mlModels | CM | T | F | F | F |
| MLTrainingJobs | M | T | F | F | F |
| MLTrainingRequests | M | T | T | F | T |
| MLTrainingReporting | M | T | T | F | T |

In some example embodiments, the MLTrainingJob IOC may represent the properties of MLTrainingJob. Besides the MLTrainingRequests and MLModels, the MLTrainingJob may be associated with one or more instances of MLTrainingReporting. The MLModels may be specified using their respective MLModelIdentifiers. The MLTrainingJob IOC may include the following attributes:

| | | | | | |
|---|---|---|---|---|---|
| Attribute name | Support Qualifier | isReadable | isWritable | isInvariant | isNotifyable |
| MLTrainingJobID | M | T | F | F | F |
| mlModels | M | T | F | F | F |
| MLTrainingRequests | M | T | T | F | T |
| MLTrainingReporting | O | T | T | F | T |

In various example embodiments, the MLTrainingRequest IOC may represent the properties of MLTrainingRequest. For each request to undertake training, a consumer may create a new MLTrainingRequest on the MLTraining (i.e., MLTrainingRequest shall be an information object class that is instantiated for each MLTrainingRequest). Each MLTrainingRequest may be associated to exactly one MLModel that is associated to the MLTraining to which the MLTrainingRequest is sent. The particular model may be specified using the MLModelIdentifier, an appropriate identifier of the ML model, and/or a version thereof. Each request may specify reporting requirements that define how the MLTraining may report the request. The MLTrainingRequest may be associated with an MLTrainingJob, if such job has been instantiated and is related to that request. For example, if the MLTraining requires that an MLTrainingJob is instantiated only after receiving a number n of MLTrainingRequests, each MLTrainingRequest may be associated with the MLTraining whenever such a job is instantiated. The request may have a source to identify its source, and which may be used to prioritize among different resources form different sources. The sources may, for example, be an enumeration defined for network functions, operator roles, or other functional differentiations. Each MLTrainingRequest may indicate one or more termination conditions that define, for the MLTraining, the conditions to be used to terminate the training. Each request may indicate one or more expected runtime contexts in which the trained model may be deployed. This context influences the training process in that the trained model should match the expected operating environment.as defined in the expected runtime contexts.

In various example embodiments, for each MLModel under training, an MLTrainingJob may be instantiated (i.e., the MLTrainingJob associated with exactly one MLModel). However, since a job may be instantiated after a set of requests, not every request shall be associated with an MLTrainingReporting instance. Instead, the reporting requirements contained in the request may be mapped to the reporting requirements of the job (i.e., either to map to an existing MLTrainingReporting instance and/or to create a new instance as needed). The reporting requirements may include an MLTrainingReportPeriod that defines the frequency at which the MLTrainingReporting should report on the MLTrainingRequest. The MLTrainingRequest IOC may include the following attributes:

| | | | | | |
|---|---|---|---|---|---|
| Attribute name | Support Qualifier | isReadable | isWritable | isInvariant | isNotifyable |
| ML TrainingRequestID | M | T | F | T | T |
| mlModelIdentifier | M | T | F | T | T |
| MLTrainingJob | M | T | F | F | F |
| Source | M | T | T | T | T |
| RequestStatus | M | T | T | F | T |
| expectedRuntimeContext | M | T | T | T | T |
| TerminationConditions | O | T | T | T | T |
| MLTrainingReportPeriod | O | T | T | T | T |

The MLTrainingReporting IOC may represent the properties of MLTrainingReporting. The MLTrainingReporting may represent the capability of compiling and delivering reports and notifications about MLTraining or its associated MLTrainingRequests, MLModels and MLTrainingJobs. The MLTraining may be associated with one or more instances of MLTrainingReporting.

In various example embodiments, the MLTrainingReporting may report on and be associated with one or more MLTrainingRequests. Similarly, the MLTrainingReporting may report on and be associated with one or more MLModels. The MLTrainingReporting may also report on and be associated with one or more MLTrainingJobs. Correspondingly, MLTrainingRequests, MLModels, and MLTrainingJobs may be conditionally mandatory, such as where at least one of them may be associated with an instance of MLTrainingReporting. An instance of MLTrainingReporting may be created for each combination of reportable objects (MLTrainingRequests, MLModels and MLTrainingJobs). As an example, the MLModels may also be associated with an MLTrainingReporting instance. This, however, may not be required for the MLModel since the model may exist for longer than, and independent of, any given MLTrainingReporting instance. Similarly, an MLTrainingRequest may not have to be associated with a specific MLTrainingReporting instance, although the MLTrainingRequests may contain requirements for reporting which must be mapped to some report. The mapping may be performed via the instantiated MLTrainingJobs which may then be associated with the reporting instance. In this way, the request may be indirectly associated to an MLTrainingReporting instance via the MLTrainingJobs to which the request is associated, and which may then have an association to one or more MLTrainingReporting instances. The MLTrainingReporting may include a ML TrainingReportingMatrix that may define the frequencies at which a report should sent, the specific entities to which each report shall be sent at each time instant, and the objects which may be included in each report.

The MLTrainingReporting may be associated with one or more MLTrainingReports. The MLTrainingReporting IOC may include the following attributes:

| | | | | | |
|---|---|---|---|---|---|
| Attribute name | Support Qualifier | isReadable | isWritable | isInvariant | isNotifyable |
| MLTrainingReportingID | M | T | F | F | F |
| mlModels | CM | T | F | F | F |
| MLTrainingRequests | CM | T | T | F | T |
| MLTrainingJobs | CM | T | T | F | T |
| MLTrainingReportingMatrix | M | T | F | F | F |
| MLTrainingReports | O | T | F | F | F |

In various example embodiments, the MLTrainingReportingRequest IOC may represent the properties of MLTrainingReportingRequest. As an example, the MLTrainingReportingRequest instance may state the respective MLModels, MLTrainingRequests, or MLTrainingJobs for which reporting is needed, and the characteristics of the respective reporting.

Given MLTrainingReportPeriod, the MLTrainingReportingRequest may be mapped to an existing MLTrainingReporting instance if the stated reporting requirements match the characteristics of the MLTrainingReporting instance. Alternatively, a new MLTrainingReporting instance may be created to match the stated reporting requirements. The MLTrainingReportingRequest IOC may include the following attributes:

| | | | | | |
|---|---|---|---|---|---|
| Attribute name | Support Qualifier | isReadable | isWritable | isInvariant | isNotifyable |
| MLTrainingReportingReque stID | M | T | F | F | F |
| mlModels | CM | T | F | F | F |
| MLTrainingRequests | CM | T | T | F | T |
| MLTrainingJobs | CM | T | T | F | T |
| MLTrainingReporting | O | T | T | F | T |
| MLTrainingReportPeriod | O | T | T | T | T |

The MLTrainingReportingMatrix dataType may represent the properties of MLTrainingReportingMatrix. The MLTrainingReportingMatrix may define the frequencies at which reports may be sent and the specific entities to which each report may be sent at each time instant. The frequencies at which reports should be sent may be defined in terms of a ReportingPeriod (e.g., in seconds as the time between two successive reports for that MLTrainingReporting instance). The consumerList is a list of DistinguishedNames of the managed functions which have requested the related report and to which the report must be delivered at that time instants defined by the ReportingPeriod. The MLTrainingReportingMatrix may include the following attributes:

| | | | | | |
|---|---|---|---|---|---|
| Attribute name | Support Qualifier | isReadable | isWritable | isInvariant | isNotifyable |
| ReportingPeriod | M | T | F | F | F |
| consumerList | M | T | F | F | F |

In some example embodiments, the MLTrainingReport dataType may represent the properties of MLTrainingReport. MLTraining may generate one or more MLTrainingReports. Each MLTrainingReport may be associated with one or more MLModels associated to the MLTraining that generate the MLTrainingReport. The MLTrainingReport may include the following attributes:

| | | | | | |
|---|---|---|---|---|---|
| Attribute name | Support Qualifier | isReadable | isWritable | isInvariant | isNotifyable |
| MLTrainingReportID | M | T | F | F | F |
| MLTrainingJobID | M | T | F | F | F |
| mlModelsList | M | T | F | F | F |
| MLTrainingRequests | O | T | F | F | F |

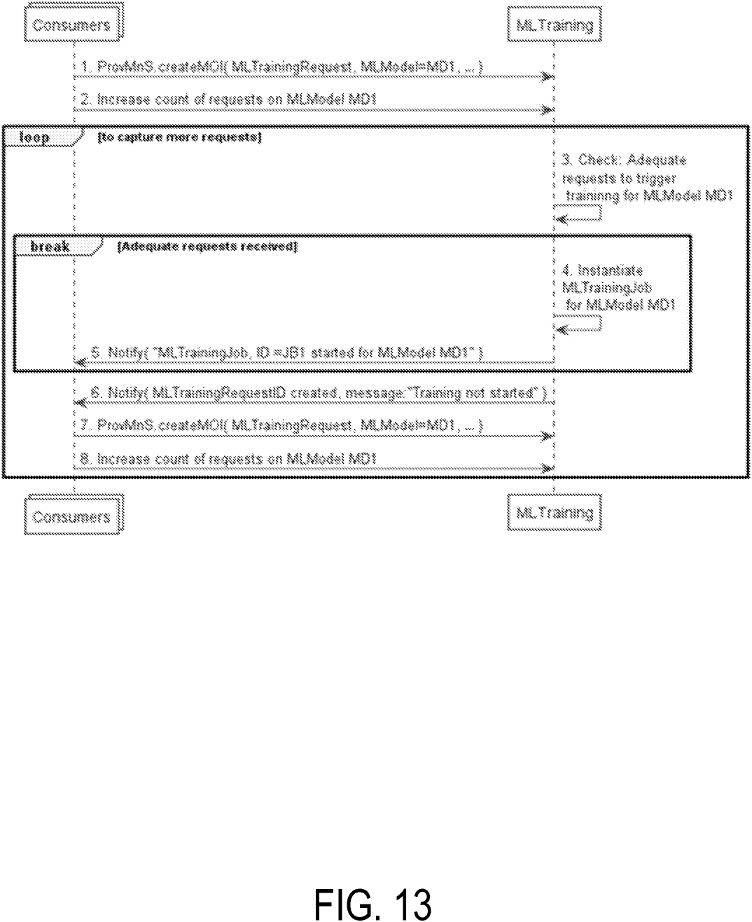

In certain example embodiments, the MLTraining may have the capability to instantiate an MLTrainingJob based on requests from consumer functions, as depicted in FIG. 13. Requests for training from network functions may be received using an MLTraining Provisioning Management service implemented via CRUD (Create, Read, Update, Delete) operations on the MLTrainingRequest objects. Requests for training may be required to state MLModel (i.e., the identifier of the specific MLModel that the consumer wishes to be trained) and/or expectedRuntimeContext (i.e., these are the operating conditions and environment in which the model is expected to be deployed and for which the consumer wishes the training to match). Additionally, each request may state TerminationConditions (i.e., these define for the MLTraining the conditions to be used to terminate the training) and/or MLTrainingReportPeriod (i.e., the frequency with which the consumer wishes to be informed about the progress of training). Following a request, the MLTraining may create an instance of MLTrainingRequest, and may update that instance with status related to that request (e.g., that an associated MLTrainingJob has been instantiated).

In various example embodiments, an MLTrainingJob may be instantiated in response to one or more MLTrainingRequests. Subsequently, MLTraining may notify the consumer who initiated the request of the corresponding action taken regarding the request. If the number of requests that have been received is inadequate to instantiate an MLTrainingJob, the MLTraining may wait for further requests, and only instantiate a training job after the adequate number of requests has been received. For example, the MLTraining may instantiate an MLTrainingJob either after receiving a number n of requests from different network functions, or after receiving a number m of requests from the same network function. MLTraining may wait for a certain time duration until more MLTrainingRequests are received. After the waiting time duration is over, MLTraining may decide to instantiate different MLTrainingJobs for received requests or simply discard some or all of the received requests if the conditions for a common job instantiation are not fulfilled.

Furthermore, an MLTrainingJob may be instantiated for MLTrainingRequests with the same ExpectedRuntimeContext and TerminationConditions. For MLTrainingRequests with different ExpectedRuntimeContext or TerminationConditions, either different MLTrainingJobs may be instantiated. Alternatively, MLTraining may combine multiple received MLTrainingRequests with different ExpectedRuntimeContext into one MLTrainingJob. For example, for Request A with ExpectedRuntimeContext Day_time and Request B with ExpectedRuntimeContext Afternoon_time, a common MLTrainingJob with ExpectedRuntimeContext No_Night_time may be instantiated.

Given requirements for reporting on MLTraining (e.g., as stated in an MLTrainingRequest), the requirements may be mapped to an existing MLTrainingReporting instance if the stated reporting requirements match the characteristics of the MLTrainingReporting instance. Alternatively, a new MLTrainingReporting instance may be created to match the stated reporting requirements. MLTrainingReporting requirements may be received through any of an MLTrainingRequest, a MLTrainingReportingRequest, and a new MLTrainingJob is instantiated.

The MLTraining may have the capability and a control interface to inform a consumer about the training (i.e., to report on an MLModels, MLTrainingRequests or MLTrainingJobs). Reporting may be accomplished either via the file- or streaming-based reporting mechanisms or via notifications.

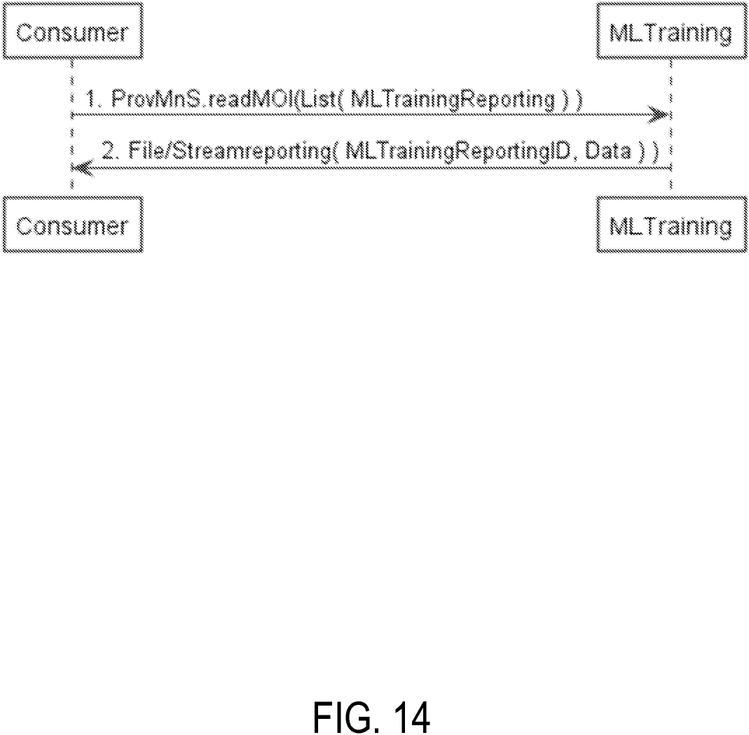

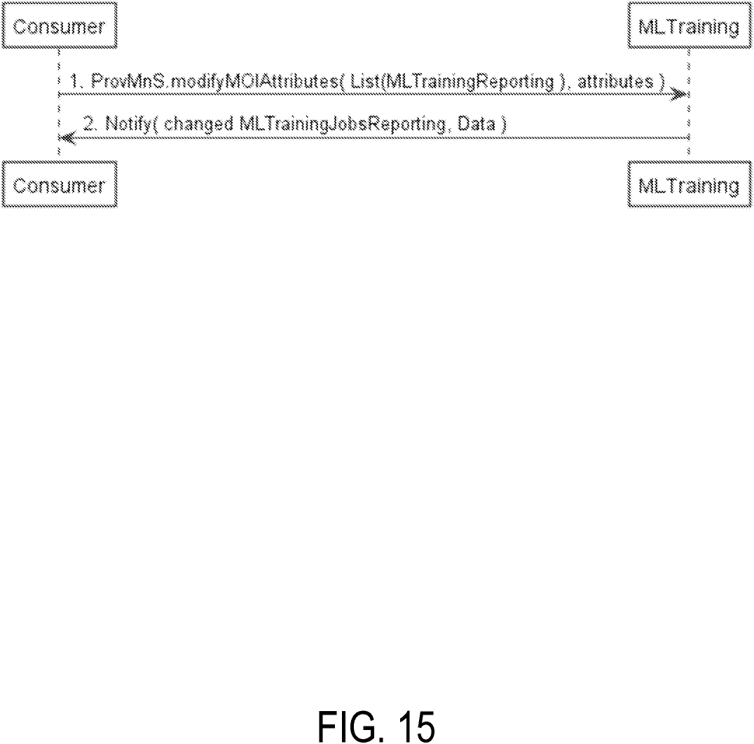

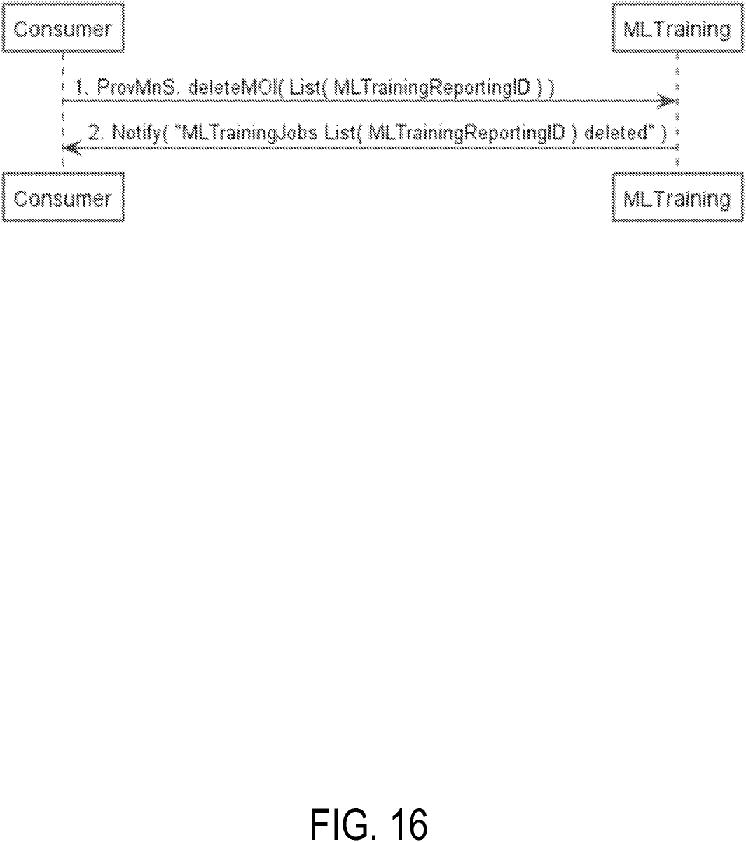

In some example embodiments, the MLTraining may have the capability and a control interface to allow a consumer (e.g., the operator) to configure and manage one or more MLTrainingReporting instances. For example, the control interface may enable the consumer to read the characteristics of ongoing or completed jobs (e.g., it may enable the consumer to read the status or maturity levels of the different MLTrainingReporting instances). This may be achieved using the readMOI procedure of a provisioning management service, as shown in FIG. 14. Additionally or alternatively, the control interface may enable the consumer to configure new and ongoing MLTrainingReporting instance(s). As shown in FIG. 15, the configuration may be achieved using the updateMOI procedure of a provisioning management service. Following an update request, the MLTraining may notify the consumer about the success of the executed update on the MLTrainingReporting instance(s). Furthermore, the control interface may enable the consumer to delete unwanted MLTrainingReporting instances, be it ongoing or completed jobs. This may be achieved using the deleteMOI procedure of a provisioning management service, as shown in FIG. 16. Following a delete request, the MLTraining may notify the consumer about the success of the executed deletion of MLTrainingReporting instances.

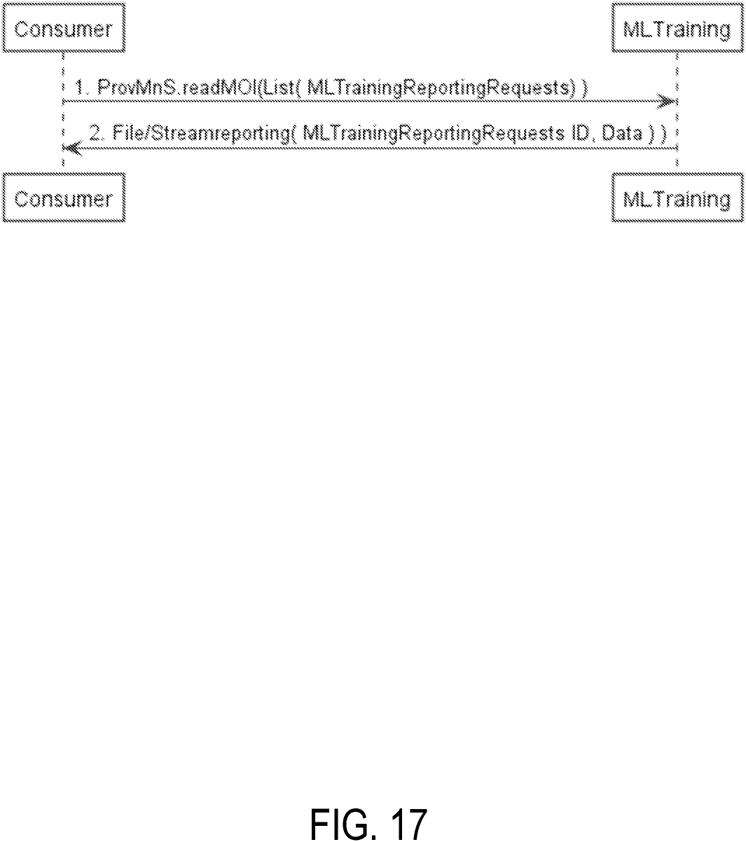

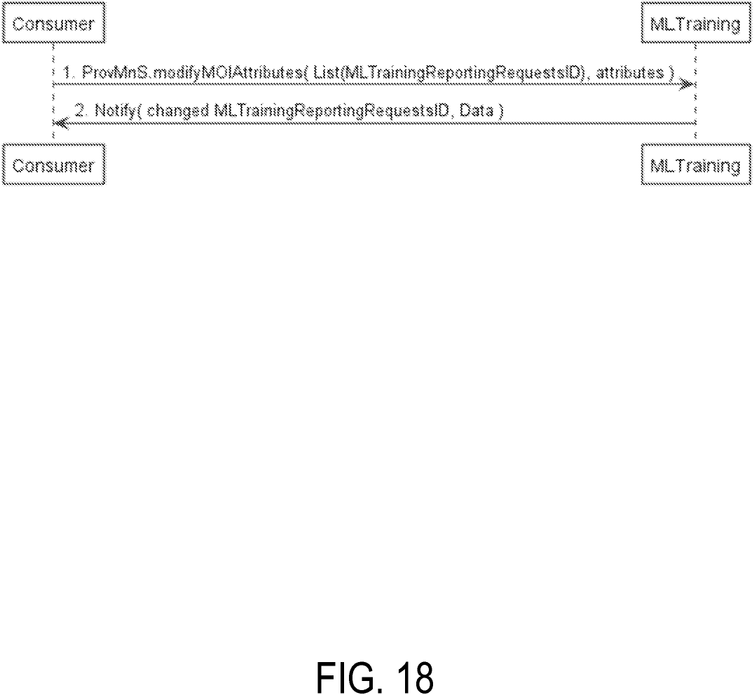

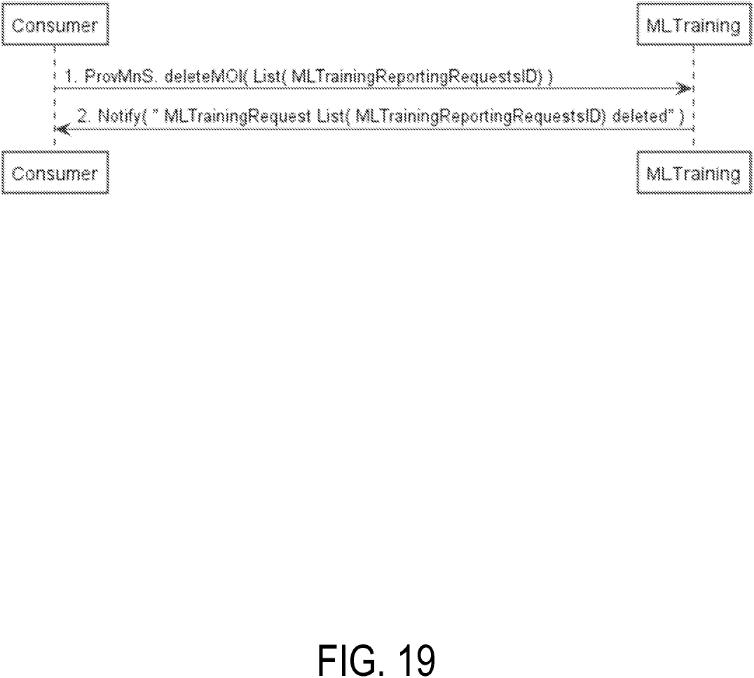

In some example embodiments, the MLTraining may have the capability and a control interface to allow a consumer (e.g., an operator) to configure and manage one or more MLTrainingReportingRequests. For example, the control interface may enable the consumer to read the characteristics of submitted MLTrainingReportingRequests. This may be achieved using the readMOI procedure of the 3GPP provisioning management service, as shown in FIG. 17. For example, the consumer may read the number of submitted, ongoing or completed MLTrainingReportingRequests, as well as the features (e.g., MLTrainingReportingMatrix, etc.) of the different submitted or ongoing MLTrainingReportingRequests. The control interface may also enable the consumer to modify the submitted MLTrainingReportingRequests. The configuration may be achieved using the updateMOI procedure of the 3GPP provisioning management service, as shown in FIG. 18. Following an update request, the MLTraining may notify the consumer about the success of the executed updates on the MLTrainingReportingRequests. Furthermore, the control interface may enable the consumer to delete unwanted MLTrainingReportingRequests. This may be achieved using the deleteMOI procedure of a provisioning management service, as shown in FIG. 19. Following a delete request, the MLTraining may terminate the related MLTrainingReporting instances or may notify the consumer about the success of the executed deletion of MLTrainingReportingRequests.

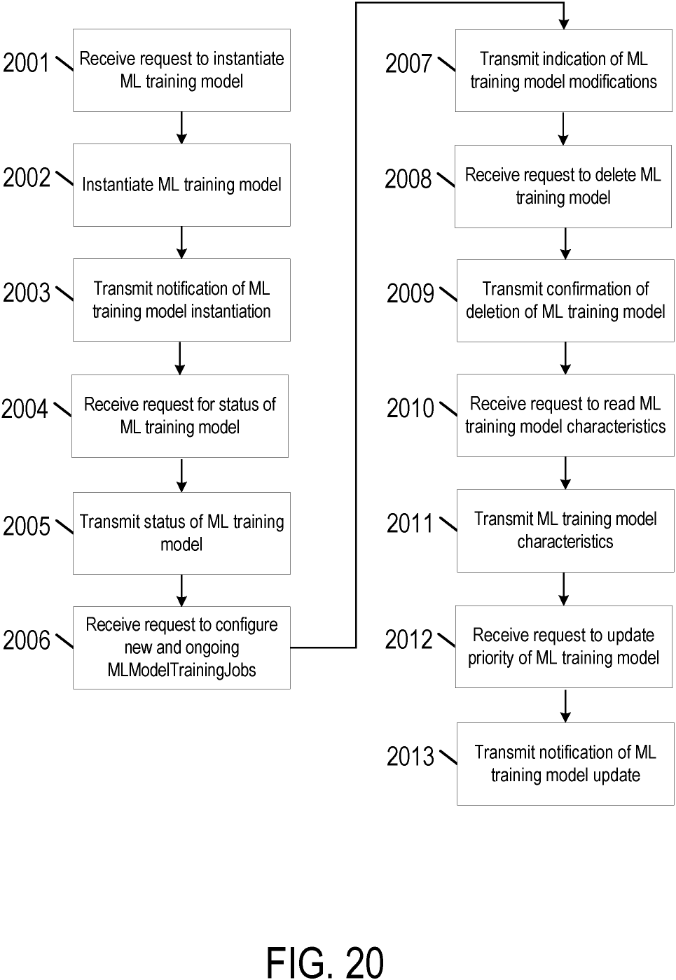

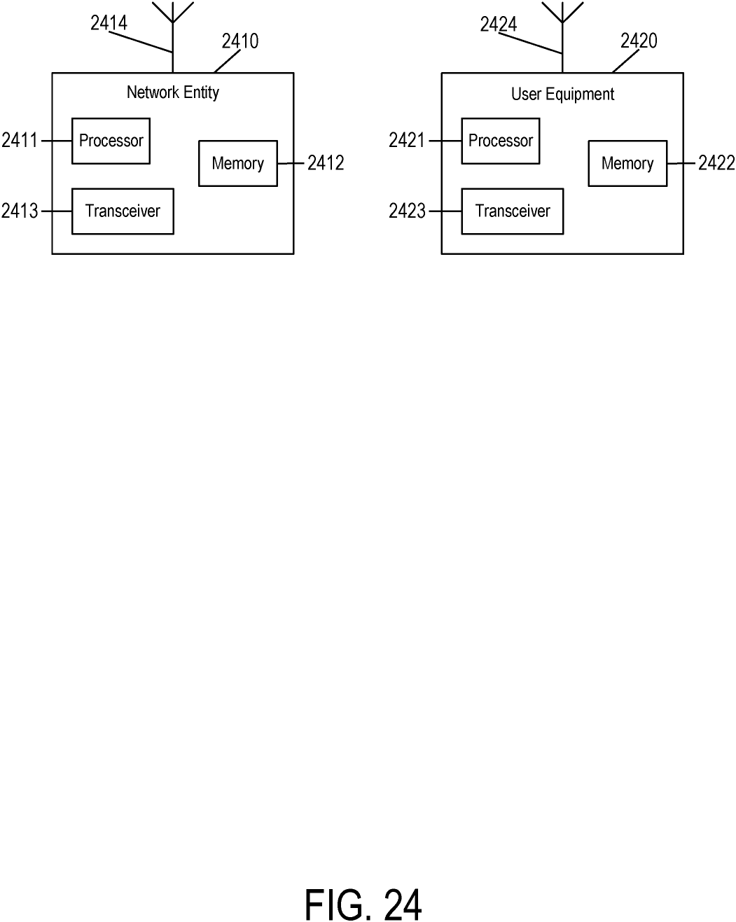

FIG. 20 illustrates an example of a flow diagram of a method that may be performed by a MLTraining, such as NE 2410 illustrated in FIG. 24, according to various example embodiments, such as those described above.

At 2001, the method may include receiving a request from a consumer (such as UE 2420 in FIG. 24) to instantiate a ML training model. At 2002, the method may include instantiating the ML training model. At 2003, the method may include transmitting a notification that the ML training model has been instantiated. At 2004, the method may include receiving a request for the status of a ML training model. At 2005, the method may include transmitting the status of the ML training model. At 2006, the method may include receiving a request to configure new and ongoing ML training models. At 2007, the method may include transmitting an indication of ML training model modifications.

At 2008, the method may include receiving a request to delete ML training models. At 2009, the method may include transmitting confirmation of deletion of a ML training model. At 2010, the method may include receiving a request to read ML training model characteristics. At 2011, the method may include transmitting ML training model characteristics. At 2012, the method may include receiving a request to update a priority of a ML training model. At 2013, the method may include transmitting a notification of a ML training model update.

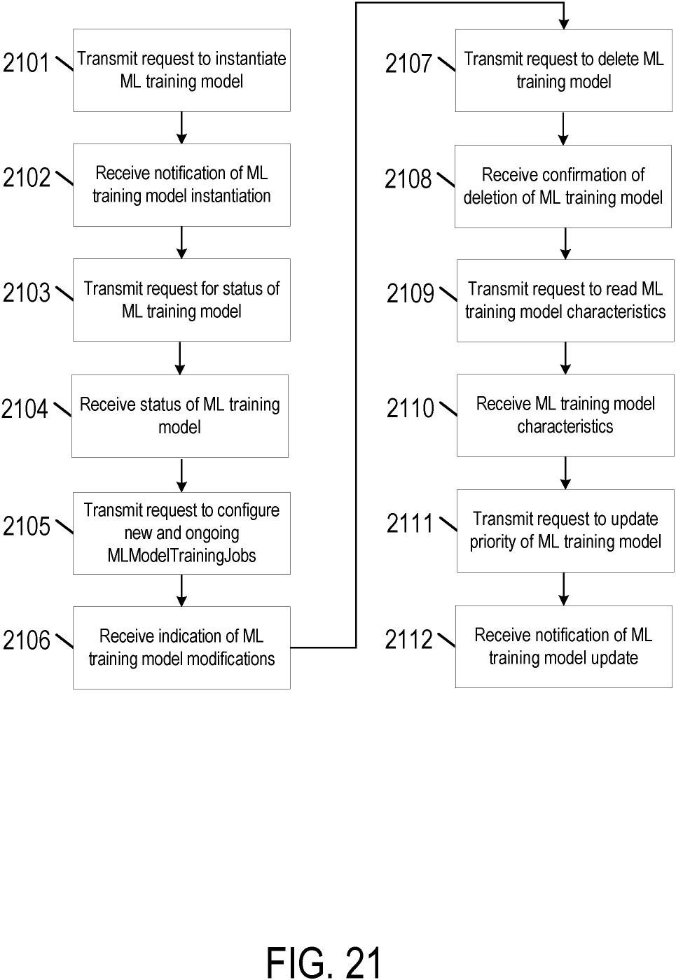

FIG. 21 illustrates an example of a flow diagram of a method that may be performed by a consumer, such as UE 2420 illustrated in FIG. 24, according to various example embodiments.

At 2101, the method may include transmitting a request to instantiate a ML training model. At 2102, the method may further include receiving notification of ML training model instantiation. At 2103, the method may further include transmitting a request for the status of a ML training model. At 2104, the method may further include receiving the status of a ML training model. At 2105, the method may further include transmitting a request to configure new and ongoing ML training models. At 2106, the method may further include receiving an indication of ML training model modifications.

At 2107, the method may further include transmitting a request to delete a ML training model. At 2108, the method may further include receiving confirmation of deletion of a ML training model. At 2109, the method may further include transmitting a request to read ML training model characteristics. At 2110, the method may further include receiving ML training model characteristics. At 2111, the method may further include transmitting a request to update a priority of a ML training model. At 2112, the method may further include receiving a notification of a ML training model update.

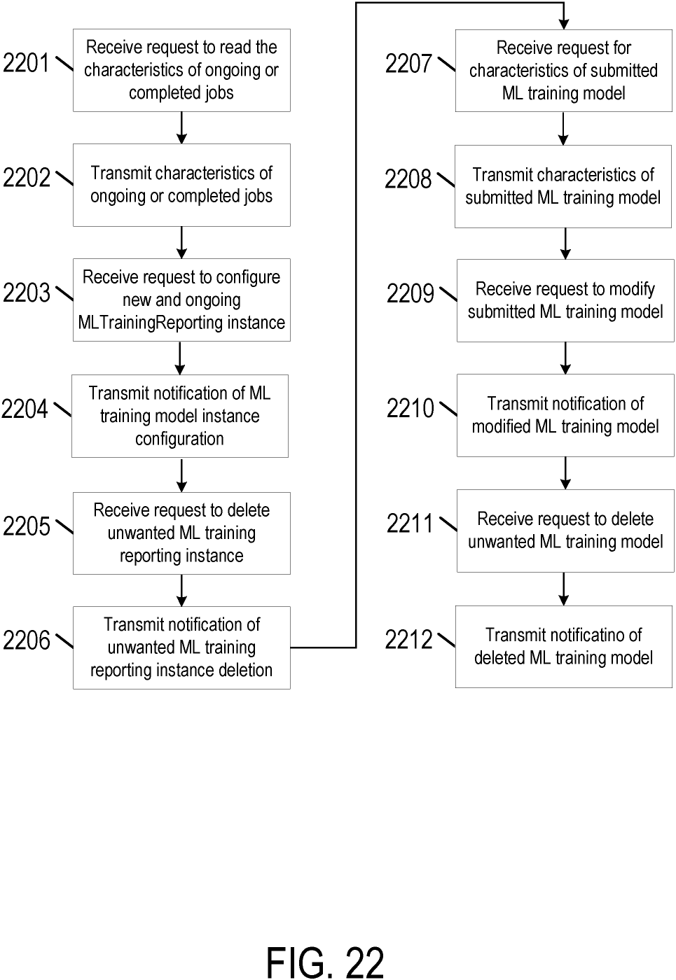

FIG. 22 illustrates an example of a flow diagram of a method that may be performed by a MLTraining, such as NE 2410 illustrated in FIG. 24, according to various example embodiments.

At 2201, the method may include receiving a request to read the characteristics of ongoing or completed jobs. At 2202, the method may further include transmitting characteristics of ongoing or completed jobs. At 2203, the method may further include receiving a request to configure new and ongoing MLTrainingReporting instance. At 2204, the method may further include transmitting a notification of ML training model instance configuration. At 2205, the method may further include receiving a request to delete unwanted ML training reporting instance. At 2206, the method may further include transmitting a notification of unwanted ML training reporting instance deletion.

At 2207, the method may further include receiving a request for characteristics of a submitted ML training model. At 2208, the method may further include transmitting characteristics of a submitted ML training model. At 2209, the method may further include receiving a request to modify a submitted ML training model. At 2210, the method may further include transmitting a notification of a modified ML training model. At 2211, the method may further include receiving a request to delete an unwanted ML training model. At 2212, the method may further include transmitting a notification of a deleted ML training model.

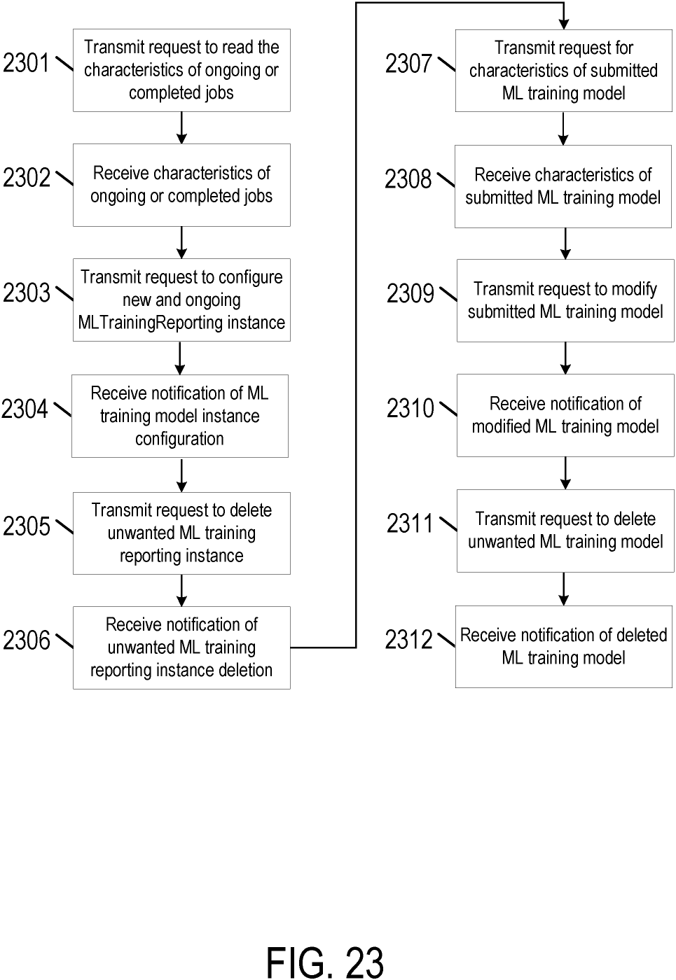

FIG. 23 illustrates an example of a flow diagram of a method that may be performed by a consumer, such as UE 2420 illustrated in FIG. 24, according to various example embodiments.

At 2301, the method may include transmitting a request to read the characteristics of ongoing or completed jobs. At 2302, the method may further include receiving characteristics of ongoing or completed jobs. At 2303, the method may further include transmitting a request to configure new and ongoing MLTrainingReporting instance. At 2304, the method may further include receiving a notification of ML training model instance configuration. At 2305, the method may further include transmitting a request to delete unwanted ML training reporting instance. At 2306, the method may further include receiving a notification of unwanted ML training reporting instance deletion.

At 2307, the method may further include transmitting a request for characteristics of a submitted ML training model. At 2308, the method may further include receiving characteristics of a submitted ML training model. At 2309, the method may further include transmitting a request to modify a submitted ML training model. At 2310, the method may further include receiving a notification of a modified ML training model. At 2311, the method may further include transmitting a request to delete an unwanted ML training model. At 2312, the method may further include receiving a notification of a deleted ML training model.

FIG. 24 illustrates an example of a system according to certain example embodiments. In one example embodiment, a system may include multiple devices, such as, for example, NE 2410 and/or UE 2420.

NE 2410 may be one or more of a base station, such as an eNB or gNB, a serving gateway, a server, and/or any other access node or combination thereof.

NE 2410 may further comprise at least one gNB-CU, which may be associated with at least one gNB-DU. The at least one gNB-CU and the at least one gNB-DU may be in communication via at least one F1 interface, at least one Xₙ-C interface, and/or at least one NG interface via a 5GC.

UE 2420 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 2410 and/or UE 2420 may be one or more of a citizens broadband radio service device (CBSD).

NE 2410 and/or UE 2420 may include at least one processor, respectively indicated as 2411 and 2421. Processors 2411 and 2421 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 2412 and 2422. The memory may be fixed or removable. The memory may include computer program instructions or computer code contained therein. Memories 2412 and 2422 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 2411 and 2421, memories 2412 and 2422, and any subset thereof, may be configured to provide means corresponding to the various blocks of FIGS. 1-23. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 24, transceivers 2413 and 2423 may be provided, and one or more devices may also include at least one antenna, respectively illustrated as 2414 and 2424. The device may have many antennas, such as an array of antennas configured for multiple input multiple output (MIMO) communications, or multiple antennas for multiple RATs. Other configurations of these devices, for example, may be provided. Transceivers 2413 and 2423 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 1-23). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 1-23. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

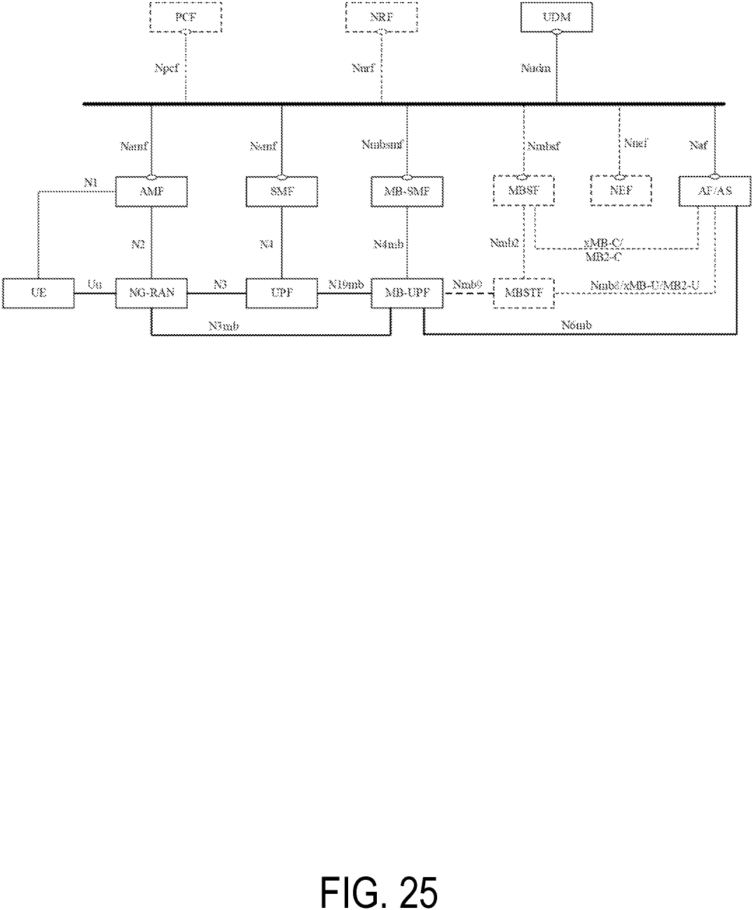

FIG. 25 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 25 may be similar to NE 2410 and UE 2420, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 2411 and 2421, and memories 2412 and 2422, may be included in or may form a part of processing circuitry or control circuitry. In addition, in some example embodiments, transceivers 2413 and 2423 may be included in or may form a part of transceiving circuitry.

In some example embodiments, an apparatus (e.g., NE 2410 and/or UE 2420) may include means for performing a method, a process, or any of the variants discussed herein. Examples of the means may include one or more processors, memory, controllers, transmitters, receivers, and/or computer program code for causing the performance of the operations.

In various example embodiments, apparatus 2410 may be controlled by processor 2411 and memory 2412 to receive a request to instantiate a machine learning training job from a consumer, instantiate the requested machine learning training job, and transmit a notification to the consumer indicating that the machine learning training job has been instantiated.

Certain example embodiments may be directed to an apparatus that includes means for performing any of the methods described herein including, for example, means for receiving a request to instantiate a machine learning training job from a consumer, means for instantiating the requested machine learning training job, and means for transmitting a notification to the consumer indicating that the machine learning training job has been instantiated.

In various example embodiments, apparatus 2420 may be controlled by processor 2421 and memory 2422 to transmit a request to instantiate a machine learning training job to a machine learning training function, and receive a notification from the machine learning training function indicating that the machine learning training job has been instantiated.

Certain example embodiments may be directed to an apparatus that includes means for performing any of the methods described herein including, for example, means for transmitting a request to instantiate a machine learning training job to a machine learning training function, and means for receiving a notification from the machine learning training function indicating that the machine learning training job has been instantiated.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

Partial Glossary

| | |
|---|---|
| 3GPP | Third Generation Partnership Project |
| 5G | Fifth Generation |
| 5GC | Fifth Generation Core |
| 5GS | Fifth Generation System |
| AI | Artificial Intelligence |
| AMF | Access and Mobility Management Function |
| ASIC | Application Specific Integrated Circuit |
| CAN | Cognitive Autonomous Networks |
| CBSD | Citizens Broadband Radio Service Device |
| CPU | Central Processing Unit |
| CRUD | Create, Read, Update, Delete |
| eMBB | Enhanced Mobile Broadband |
| eMTC | Enhanced Machine Type Communication |
| eNB | Evolved Node B |
| eOLLA | Enhanced Outer Loop Link Adaptation |
| gNB | Next Generation Node B |
| GPS | Global Positioning System |
| HDD | Hard Disk Drive |
| IEEE | Institute of Electrical and Electronics Engineers |
| IOC | Information Object Classes |
| LTE | Long-Term Evolution |
| LTE-A | Long-Term Evolution Advanced |
| MEMS | Micro Electrical Mechanical System |
| ML | Machine Learning |
| MME | Mobility Management Entity |
| MnS | Management Service |
| MOI | Managed Object Instance |
| mMTC | Massive Machine Type Communication |
| MPDCCH | Machine Type Communication Physical Downlink |
| Control Channel | |
| MTC | Machine Type Communication |
| NE | Network Entity |
| NG | Next Generation |
| NG-eNB | Next Generation Evolved Node B |
| NG-RAN | Next Generation Radio Access Network |
| NR | New Radio |
| NR-U | New Radio Unlicensed |
| OAM | Operations, Administration, and Management |
| PDA | Personal Digital Assistance |
| RAM | Random Access Memory |
| RAN | Radio Access Network |
| RAT | Radio Access Technology |
| UE | User Equipment |
| UMTS | Universal Mobile Telecommunications System |
| URLLC | Ultra-Reliable and Low-Latency Communication |
| UTRAN | Universal Mobile Telecommunications System |
| Terrestrial Radio Access Network | |
| WLAN | Wireless Local Area Network |

We claim:

1. A method, comprising:
receiving, by a machine learning training function, a request to instantiate a machine learning training job from a consumer;
instantiating, by the machine learning training function, the requested machine learning training job; and
transmitting, by the machine learning training function, a notification to the consumer indicating that the machine learning training job has been instantiated.

2. The method of claim 1, further comprising:
receiving, by the machine learning training function, a request from the consumer to read a managed object instance associated with a list of machine learning training jobs; and
transmitting, by the machine learning training function, a list of machine learning training jobs identifiers to the consumer.

3. The method of claim 1, further comprising:
receiving, by the machine learning training function, a request from the consumer to modify managed object instance attributes associated with a list of machine learning training jobs identifiers; and
transmitting, by the machine learning training function, a notification to the consumer of the list of modified machine learning training jobs identifiers.

4. The method of claim 1, further comprising:
receiving, by the machine learning training function, a request from the consumer to delete managed object instance attributes associated with a list of machine learning training jobs identifiers; and
transmitting, by the machine learning training function, a notification to the consumer of the list of deleted machine learning training jobs identifiers.

5. A method, comprising:
transmitting, by a consumer, a request to instantiate a machine learning training job to a machine learning training function; and
receiving, by the consumer, a notification from the machine learning training function indicating that the machine learning training job has been instantiated.

6. The method of claim 5, further comprising:
transmitting, by the consumer, a request to the machine learning training function to read a managed object instance associated with a list of machine learning training jobs; and
receiving, by the consumer, a list of machine learning training jobs identifiers from the machine learning training function.

7. The method of claim 5, further comprising:
transmitting, by the consumer, a request from the consumer to modify managed object instance attributes associated with a list of machine learning training jobs identifiers; and
receiving, by the consumer, a notification from the machine learning training function of the list of modified machine learning training jobs identifiers.

8. The method of claim 5, further comprising:
transmitting, by the consumer, a request from the consumer to delete managed object instance attributes associated with a list of machine learning training jobs identifiers; and
receiving, by the consumer, a notification from the machine learning training function of the list of deleted machine learning training jobs identifiers.

9. An apparatus, comprising:
at least one processor; and
at least one memory including computer program code,
wherein the at least one memory and the computer program code are configured to, with the at least one processor, cause the apparatus at least to perform a method according to:
receiving a request to instantiate a machine learning training job from a consumer;
instantiating the requested machine learning training job; and
transmitting a notification to the consumer indicating that the machine learning training job has been instantiated.

10. The apparatus according to claim 9, wherein the at least one memory and computer program code are further configured, with the at least one processor, to cause the apparatus to perform:
receiving a request from the consumer to read a managed object instance associated with a list of machine learning training jobs; and
transmitting a list of machine learning training jobs identifiers to the consumer.

11. The apparatus according to claim 9, wherein the at least one memory and computer program code are further configured, with the at least one processor, to cause the apparatus to perform:
receiving a request from the consumer to modify managed object instance attributes associated with a list of machine learning training jobs identifiers; and
transmitting a notification to the consumer of the list of modified machine learning training jobs identifiers.

12. The apparatus according to claim 9, wherein the at least one memory and computer program code are further configured, with the at least one processor, to cause the apparatus to perform:
receiving a request from the consumer to delete managed object instance attributes associated with a list of machine learning training jobs identifiers; and
transmitting, by the machine learning training function, a notification to the consumer of the list of deleted machine learning training jobs identifiers.

13. An apparatus, comprising:
at least one processor; and
at least one memory including computer program code,
wherein the at least one memory and the computer program code are configured to, with the at least one processor, cause the apparatus at least to perform:
transmitting a request to instantiate a machine learning training job to a machine learning training function; and
receiving a notification form the machine learning training function indicating that the machine learning training job has been instantiated.

14. The apparatus according to claim 13, wherein the at least one memory and computer program code are further configured, with the at least one processor, to cause the apparatus to perform:
transmitting, by the consumer, a request to the machine learning training function to read a managed object instance associated with a list of machine learning training jobs; and
receiving, by the consumer, a list of machine learning training jobs identifiers from the machine learning training function.

15. The apparatus according to claim 13, wherein the at least one memory and computer program code are further configured, with the at least one processor, to cause the apparatus to perform:
transmitting, by the consumer, a request from the consumer to modify managed object instance attributes associated with a list of machine learning training jobs identifiers; and
receiving, by the consumer, a notification from the machine learning training function of the list of modified machine learning training jobs identifiers.

16. The apparatus according to claim 13, wherein the at least one memory and computer program code are further configured, with the at least one processor, to cause the apparatus to perform:
transmitting, by the consumer, a request from the consumer to delete managed object instance attributes associated with a list of machine learning training jobs identifiers; and
receiving, by the consumer, a notification from the machine learning training function of the list of deleted machine learning training jobs identifiers.

17. A non-transitory computer-readable medium comprising program instructions stored thereon for performing the method according to claim 1.

18. A non-transitory computer-readable medium comprising program instructions stored thereon for performing the method according to claim 5.
